(19) United States
(12) Patent Application Publication
(10) Pub. No.: US 2006/0222355 A1
(43) Pub. Date: Oct. 5, 2006

(54) Auto-focusing camera

(75) Inventor: Te-An Yin, Taipei (TW)

Correspondence Address: NIKOLAI & MERSEREAU, P.A., 900 SECOND AVENUE SOUTH, SUITE 820, MINNEAPOLIS, MN, 55402, US

(73) Assignee: Inchan Technology Co., Ltd., Sindian City (TW)

(21) Appl. No.: 11/389,679

(22) Filed: Mar. 27, 2006

(30) Foreign Application Priority Data
Mar. 30, 2005 (TW) 094204898

(51) Int. Cl. G03B 13/18

(52) U.S. Cl. 396/89

(57) ABSTRACT

An auto-focusing camera has a base, a focusing element, a lens, a motor and a transmission assembly. The focusing element is mounted movably on the base. The lens is mounted on the focusing element. The motor is mounted and lies flatly on the base and has a shaft mounted rotatably to the motor. The transmission assembly connects to the shaft on the motor and the focusing element and allows the motor to move the focusing element through the transmission assembly. The motor lying on the base decreases a thickness of the auto-focusing camera along an axis of the lens and makes the auto-focusing camera thin and compact. The electrical appliance with the auto-focusing camera is thin, compact and salable.

### BACKGROUND OF THE INVENTION

1. Field of the Invention

The present invention relates to a camera, and more particularly to an auto-focusing camera that is thin and compact.

2. Description of Related Art

Cellular phones nowadays are designed to be compact with multiple functions to increase their marketability. One of popular functions of present cellular phones greatly increasing the marketability is photographing, which is implemented with a compact digital camera.

With reference to FIG. 6, a conventional digital camera mounted in a cellular phone comprises a base (90), a motor (91), a focusing element (92), a lens (93), a connector (91) and a circuit board. The motor (91) is mounted upright on the base (90) and has an axis perpendicular to the base (90) and a threaded shaft (911) mounted rotatably on the motor (91). The focusing element (92) is mounted movably on the base (90). The lens (93) is mounted to the focusing element (92) and has an axis parallel to the axis of the motor (91). The connector (94) is screwed to the threaded shaft (911) and connects to the focusing element (92) so the motor (91) can move the lens (93) away from or toward the base (90) by rotating the threaded shaft (911). The circuit board connects to and controls the motor (91).

However, the motor (91) mounted upright on the base (90) increases the thickness of the whole digital camera along the axes of the motor (91) and lens (93). To receive the digital camera with an increased thickness, the cellular phone must become thicker and therefore in-compact, which makes the digital camera undesirable and un-salable.

To overcome the shortcomings, the present invention provides an auto-focusing camera to mitigate or obviate the aforementioned problems.

### SUMMARY OF THE INVENTION

The main objective of the invention is to provide an auto-focusing camera that is thin and compact.

An auto-focusing camera in accordance with the present invention comprises a base, a focusing element, a lens, a motor and a transmission assembly.

The focusing element is mounted movably on the base.

The lens is mounted on the focusing element.

The motor is mounted and lies flatly on the base and has a shaft mounted rotatably to the motor.

The transmission assembly connects to the shaft on the motor and the focusing element and allows the motor to move the focusing element through the transmission assembly.

Other objectives, advantages and novel features of the invention will become more apparent from the following detailed description when taken in conjunction with the accompanying drawings.

### BRIEF DESCRIPTION OF THE DRAWINGS

FIG. 1 is a partially exploded perspective view of an auto-focusing camera in accordance with the present invention;

FIG. 2 is an exploded perspective view of the auto-focusing camera in FIG. 1;

FIG. 3 is another exploded perspective view of the auto-focusing camera in FIG. 1;

FIG. 4 is a side view in partial section of the auto-focusing camera in FIG. 1;

FIG. 5 is an operational side view in partial section of the auto-focusing camera with the focusing element and the lens moved away from the base by the motor; and

FIG. 6 is a perspective view of a conventional camera in accordance with the prior art.

### DETAILED DESCRIPTION OF THE PREFERRED EMBODIMENT

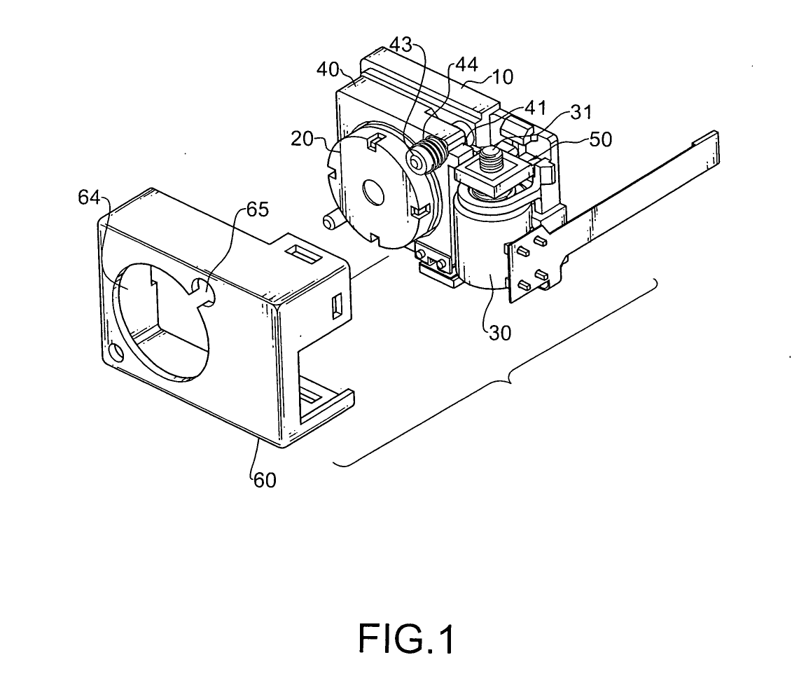

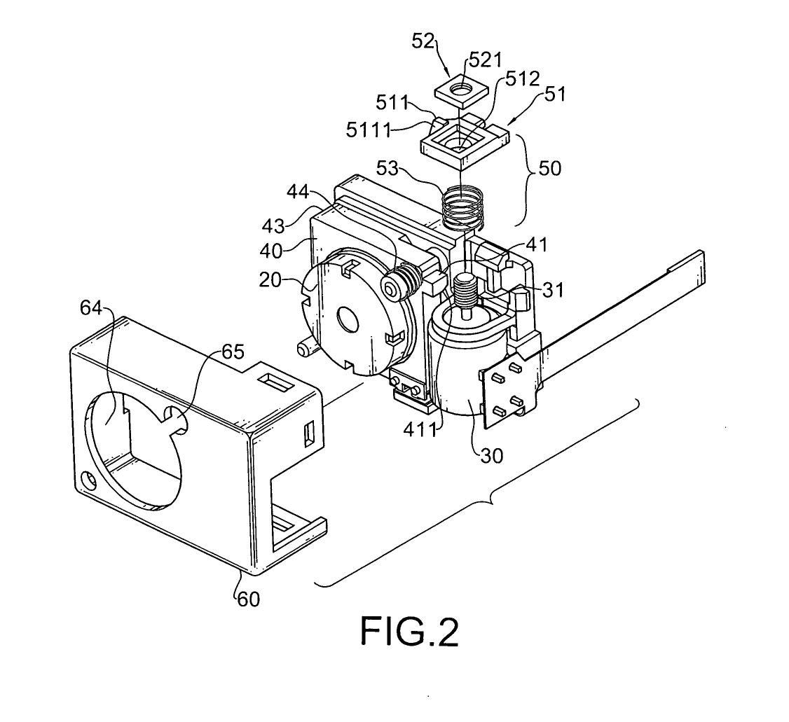

With reference to FIGS. 1 and 2, a auto-focusing camera in accordance with the present invention may be a digital camera, is mounted in an electrical appliance such as a cellular phone and comprises a base (10), a focusing element (40), a lens (20), a motor (30), a transmission assembly (50) and a cover (60).

The base (10) is mounted in the electrical appliance and has a front.

The focusing element (40) is mounted movably on the front of the base (10), can move away from or toward the base (10) and has a front, an outer edge, a driven element (41), a cylinder (43) and a spring (44). The driven element (41) is formed on the outer edge and has an inclined surface (411) relative to the front of the base (10). The cylinder (43) perpendicularly extends out the front of the focusing element (40). The spring (44) is mounted around the cylinder (43).

The lens (20) is mounted on the front of the focusing element (40) and has an axis perpendicular to the front of the base (10) and a focal distance which can be adjusted by movement of the focusing element (40).

The motor (30) is mounted and lies flatly on the front of the base (10) and has an axis and a threaded shaft (31). The axis of the motor (30) is perpendicular to the axis of the lens (20). The threaded shaft (31) is mounted rotatably on the motor (30).

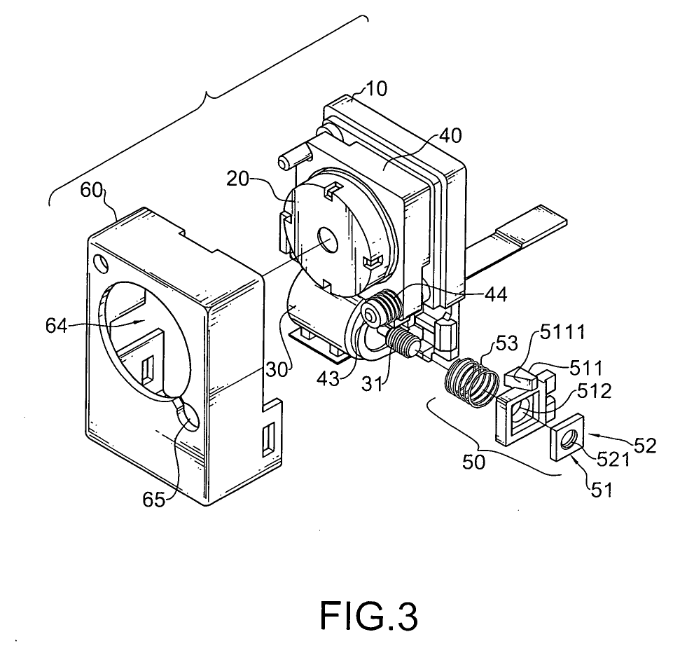

With reference FIGS. 2 and 3, the transmission assembly (50) connects to the threaded shaft (31) on the motor (30) and the driven element (41) of the focusing element (40) and allows the motor (30) to move the focusing element (40) through the transmission assembly (50). The transmission assembly (50) has an actuator (51), a shaft mount (52) and a spring (53).

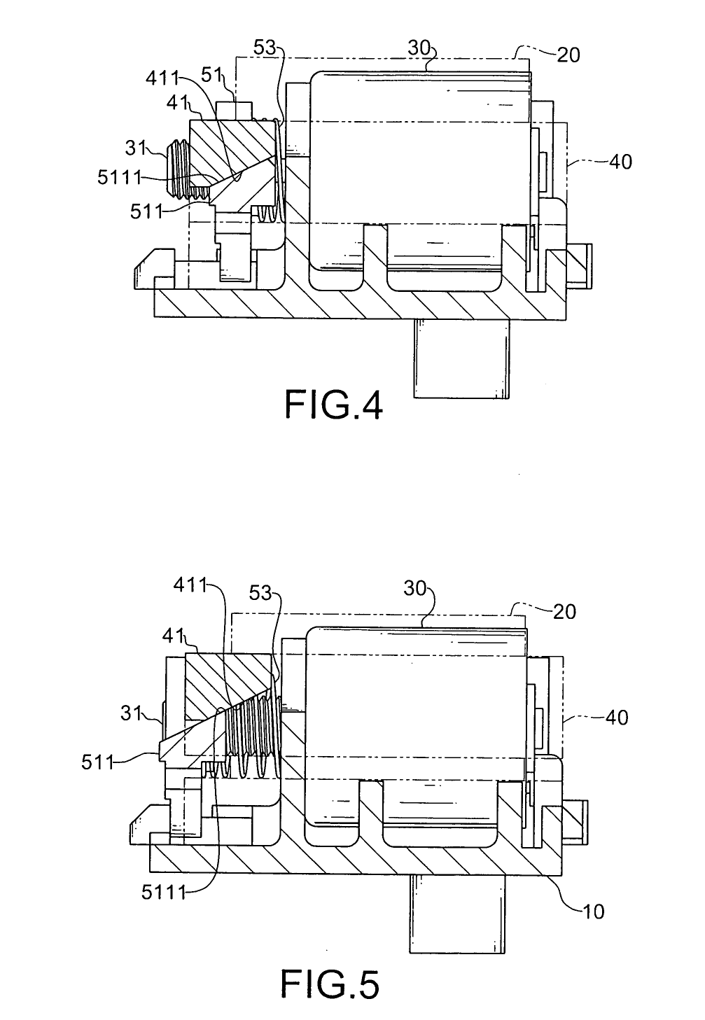

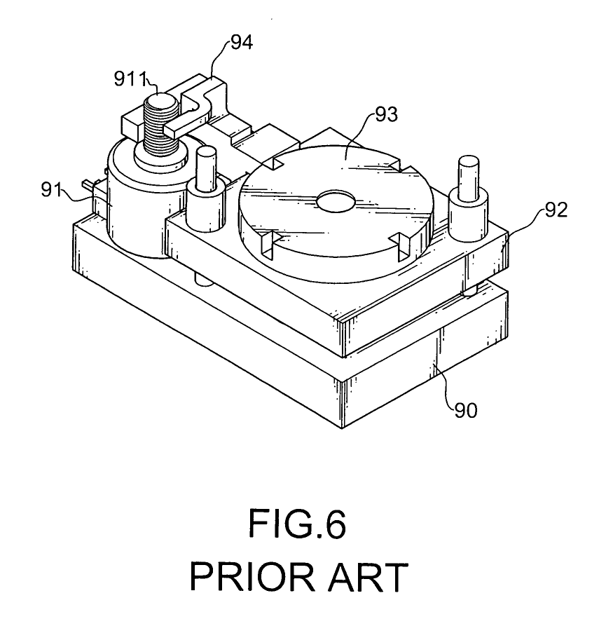

The actuator (51) is mounted movably around the threaded shaft (31), engages and selectively moves the focusing element (40) toward or away from the base (10) and has an outer edge, a driving element (511) and a through hole (512). The driving element (511) is formed on the outer edge of the actuator (51), slidably engages the driven element (41) and has an inclined surface (5111). The inclined surface (5111) of the driving element (511) slidably contacts the inclined surface (411) of the driven element (41). With reference to FIGS. 4 and 5, a sliding movement between the inclined surfaces (411, 5111) moves the focusing element (40) along the axis of the lens (20) toward or away from the base (10) to adjust the focal length of the lens (20). The through hole (512) is defined through the actuator (51) and through which the threaded shaft (31) extends.

In a first embodiment of the transmission assembly (50), the shaft mount (52) is screwed on the threaded shaft (31) and has a threaded hole (521) defined through the shaft mount (52) and holding the threaded shaft (31). In a second embodiment of the transmission assembly (50), the shaft mount (52) is formed integrally on the actuator (51). The second embodiment is not illustrated in any figures, however can be reasonable expected by referring to FIGS. 2 and 3.

In the first embodiment of the transmission assembly (50), the spring (53) is mounted around the threaded shaft (31) and has two ends. One end of the spring (53) presses against the motor (30) and the other end presses the actuator (51) against the shaft mount (52) so that rotating the threaded shaft (31) can move the actuator (51) back or forth along the threaded shaft (31) and simultaneously move the focusing element (40) toward or away from the base (10). In the second embodiment of the transmission assembly (50), the spring (31) is unnecessary and is omitted because the actuator (51) and shaft mount (52) are formed integrally and move together.

The cover (60) is mounted on the base (10), covers the focusing element (40), the lens (20), the motor (30) and the transmission assembly (50) and has an inner surface, a window (64) and a through hole (65). The inner surface presses the spring (44) on the cylinder (43) against the focusing element (40) and prevents the focusing element (40) from moving inadvertently. The window (64) is defined through the cover (60) and is aligned with lens (20). The through hole (65) is defined through the cover (60) and through which the cylinder (43) extends.

The motor (31) lying on the base (10) decreases a thickness of the auto-focusing camera along the axis of the lens (20) and makes the auto-focusing camera thin and compact. The internal space in the electrical appliance required for receiving the auto-focusing camera is less than that for a conventional auto-focusing camera. Therefore the electrical appliance with the auto-focusing camera is thin, compact and salable.

Even though numerous characteristics and advantages of the present invention have been set forth in the foregoing description, together with details of the structure and function of the invention, the disclosure is illustrative only. Changes may be made in the details, especially in matters of shape, size, material, and arrangement of parts within the principles of the invention to the full extent indicated by the broad general meaning of the terms in which the appended claims are expressed.

What is claimed is:

1. A auto-focusing camera comprising:
a base having a front;
a focusing element mounted movably on the front of the base;
a lens mounted on the focusing element and having an axis perpendicular to the front of the base and a focal distance adjusted by movement of the focusing element;
a motor mounted and lying flatly on the base and having an axis perpendicular to the axis of the lens and a shaft mounted rotatably to the motor; and
a transmission assembly connecting to the shaft on the motor and the focusing element and allowing the motor to move the focusing element through the transmission assembly.

2. The auto-focusing camera as claimed in claim 1, wherein:
the shaft is threaded;
the focusing element has an outer edge and a driven element formed on the outer edge and having an inclined surface; and
the transmission assembly has
an actuator mounted movably around the shaft, engaging and selectively moving the focusing element toward or away from the base and having an outer edge, a driving element formed on the outer edge of the actuator, slidably engaging the driven element on the focusing element and having an inclined surface slidably contacting the inclined surface of the driven element and a through hole defined through the actuator and through which the threaded shaft extends;
a shaft mount screwed on the threaded shaft and having a threaded hole defined through the shaft mount and holding the threaded shaft; and
a spring mounted around the threaded shaft, having two ends, one of the ends pressing against the motor and the other end pressing the actuator against the shaft mount.

3. The auto-focusing camera as claimed in claim 1, wherein:
the shaft is threaded;
the focusing element has an outer edge and a driven element formed on the outer edge and having an inclined surface; and
the transmission assembly has
an actuator mounted movably around the shaft, engaging and selectively moving the focusing element toward or away from the base and having an outer edge, a driving element formed on the outer edge of the actuator, slidably engaging the driven element on the focusing element and having an inclined surface slidably contacting the inclined surface of the driven element and a through hole defined through the actuator and through which the threaded shaft extends; and
a shaft mount formed integrally on the actuator and having a threaded hole defined through the shaft mount and holding the threaded shaft.

4. The auto-focusing camera as claimed in claim 2, wherein:
the focusing element further has a cylinder perpendicularly extending out the front of the focusing element and a spring mounted around the cylinder; and
a cover is mounted on the base and covers the focusing element, the lens, the motor and the transmission assembly and has
an inner surface pressing the spring on the cylinder against the focusing element;
a window defined through the cover and aligned with lens; and
a through hole defined through the cover and through which the cylinder extends.

5. The auto-focusing camera as claimed in claim 3, wherein:
the focusing element further has a cylinder perpendicularly extending out the front of the focusing element and a spring mounted around the cylinder; and
a cover is mounted on the base and covers the focusing element, the lens, the motor and the transmission assembly and has
an inner surface pressing the spring on the cylinder against the focusing element;
a window defined through the cover and aligned with lens; and
a through hole defined through the cover and through which the cylinder extends.
